(19) United States
(12) Patent Application Publication
(10) Pub. No.: US 2004/0150663 A1
(43) Pub. Date: Aug. 5, 2004

(54) System and method for editing multimedia file using internet

(75) Inventor: Yu-hyok Kim, Sungnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/754,708

(22) Filed: Jan. 12, 2004

(30) Foreign Application Priority Data
Jan. 14, 2003 (KR) 10-2003-0002459

(51) Int. Cl. G09G 5/00

(52) U.S. Cl. 345/723

(57) ABSTRACT

The present invention relates to a client, server, and method for editing a multimedia file using a network. The invention includes a client for uploading the multimedia file and a multimedia editing command file, as well as a server for editing the multimedia file uploaded from the client by using its own resources in accordance with the multimedia editing command file.

### BACKGROUND OF THE INVENTION

This application claims foreign priority under 35 U.S.C. § 119, based on Korean Application No. 10-2003-0002459, filed Jan. 14, 2003, the disclosure of which is incorporated herein by reference.

1. Field of the Invention

The present invention relates to a client, server, and method for editing a multimedia file using the Internet, and more particularly, to a client, server, and method for editing a multimedia file using the Internet such that when a client creates a video file to be edited into a multimedia editing command file and transmits the multimedia editing command file to a server, the server edits the video file using resources stored therein, in accordance with the transmitted multimedia editing command file.

2. Description of the Related Art

Korean Patent Laid-Open Publication No. 2002-0065695, entitled “Digital Video Editing System using On-line System” discloses a related art on-line digital video editing system in which a plurality of users can easily perform digital imaging works, such as video image presentation and video production by using an additional space where an automatic digital video editing solution is provided.

In the related art on-line digital video editing system, however, CD media for user authentication is always needed. Further, a multimedia file should be edited after being downloaded from a server to a client, and the edited file should be uploaded to the server. Thus, there is a related art problem in that a large load is imposed on the network. Further, there is another related art problem in that the client should have good performance since the video should be edited directly on the client, but this good performance is substantially prevented for at least the reasons discussed above.

Korean Patent Laid-Open Publication No. 2002-0031658, entitled “System for Producing Video Materials using a Wireless Internet Terminal” discloses a related art video production system using a wireless Internet terminal, wherein a movie can be shown in the form of video on demand based on a user request of a user connected to an on-line movie production server. This is accomplished by downloading predetermined video material from a video database of the on-line movie production server, editing and producing the movie based on the downloaded video material, and again uploading the produced movie to the on-line movie production server.

However, there is also a related art problem for this related art system, in that a large load is imposed on the network, since the video material should be downloaded from the video database of the on-line movie production server and the movie should be produced by using the downloaded video material and then uploaded to the on-line movie production server. Further, there is another related problem in that the client should have good performance since the movie should be edited directly on the client, and for at least the foregoing reasons, this good performance is substantially prevented.

### SUMMARY OF THE INVENTION

An object of the present invention is to provide a client, server and method for editing a multimedia file using a network, such as the Internet, wherein a multimedia editing program can be downloaded through the Internet so that a video file can be edited without provision of additional program media.

Another object of the present invention is to provide a client, server and method for editing a multimedia file using a network, wherein if a client creates a video file to be edited into a multimedia editing command file and transmits the command file to a server, a server edits the video file by using resources stored therein in accordance with the transmitted multimedia editing command file.

A further object of the present invention is to provide a client, server and method for editing a multimedia file using a network, wherein only a multimedia file editing program and resource information can be downloaded so that data transmission can be minimized and thus load on a network can be reduced.

According to an aspect of the present invention for achieving the objects, there is provided a client linked with a server through a network, such as the Internet, wherein the client is operable to upload a video file to one or more network components, create a multimedia editing command file using a multimedia editing program, and request editing of the video file in accordance with the multimedia editing command file.

According to another aspect of the present invention, there is provided a server, said server linked to a client through a network, the server operable to receive a multimedia editing command file transmitted from the client and edit a video file stored in the server in accordance with the multimedia editing command file.

According to a further aspect of the present invention, there is provided a multimedia file editing system linked to a client through a network, the multimedia file editing system comprising the aforementioned client and server.

According to another aspect of the present invention, there is provided a method for editing a multimedia file, comprising the steps of (1) in a client, creating a multimedia editing command file by using resource information downloaded from a server; (2) transmitting the created multimedia editing command file to the server; and (3) in the server, editing a video file by using resources stored in the server that correspond to the resource information used to create the transmitted multimedia editing command file. According to still another aspect of the present invention, there is provided a computer readable medium containing a set of instructions for editing a multimedia file, said instructions comprising the steps of receiving a multimedia editing command file created by a client using resource information and transmitted by the client; and (2) editing a video file in accordance with the received multimedia editing command file. Of course, any of the aforementioned methods can be implemented by a computer readable medium containing a set of instructions which is also described herein.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a block diagram schematically illustrating a configuration of a system for editing a multimedia file using the Internet according to an exemplary, non-limiting embodiment of the present invention;

FIG. 2 is a flowchart schematically illustrating a method for editing a multimedia file using the Internet according to an exemplary, non-limiting embodiment of the present invention;

FIG. 3 is a flowchart specifically illustrating step S100 of the method for editing the multimedia file using the Internet according to an exemplary, non-limiting embodiment of the present invention;

FIG. 4 is a flowchart specifically illustrating step S160 of the method for editing the multimedia file using the Internet according to an exemplary, non-limiting embodiment of the present invention;

FIG. 5 is a flowchart specifically illustrating step S190 of the method for editing the multimedia file using the Internet according to an exemplary, non-limiting embodiment of the present invention;

FIGS. 6a to 6d are graphics illustrating examples of editing a video using a multimedia editing program according to an exemplary, non-limiting embodiment of the present invention.

### DETAILED DESCRIPTION OF THE INVENTION

Hereinafter, a preferred embodiment of the present invention will be explained in detail with reference to the accompanying drawings.

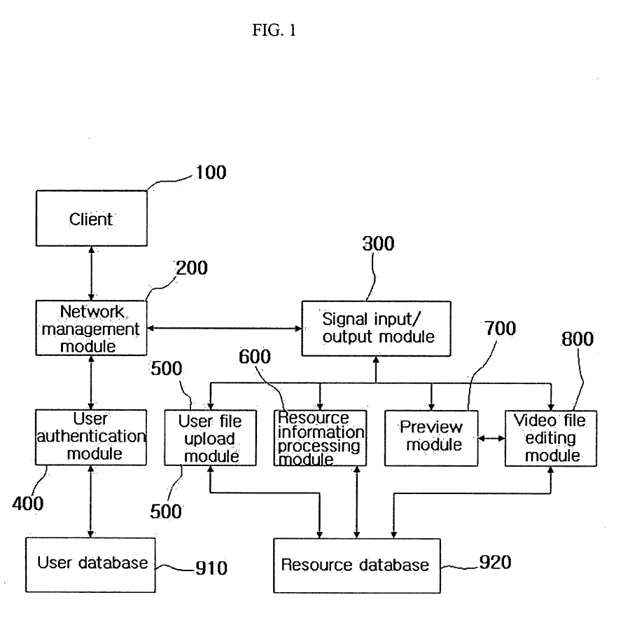

FIG. 1 is a block diagram schematically illustrating a system for editing a multimedia file using the Internet according to the present invention. The multimedia file editing system comprises a client 100, a network management module 200, a signal input/output module 300, a user authentication module 400, a user file upload module 500, a resource information processing module 600, a preview module 700, a video file editing module 800, a user database 910, and a resource database 920.

The client 100 is a terminal, such as a computer, a notebook computer, a PDA or a web pad, on which a multimedia editing program is executed.

The signal input/output module 300 distributes signals (e.g., file upload signals, resource information request signals, preview request signals, video file editing command signals) input from the client 100 among respective modules, and conversely, transmits signals output from the respective modules to the client 100.

The user authentication module 400 performs user authentication when a user connects with a server through the client 100. That is, the user authentication module receives user information from the user database 910 and then performs the user authentication. The user database 910 stores information on users who become members, and provides the information on the connected user when the user authentication module 400 performs the user authentication.

The user file upload module 500 stores a file uploaded from the client 100 in the resource database 920.

The resource information processing module 600 transmits resource information stored in the resource database 920 to the client 100 when the client 100 requests transmission of the resource information. Here, the resource information is information on resources (i.e. video clips, texts, icons representative of the resources). The term “resources” is a general term for indicating various kinds of files necessary for editing the video files. The resources may include (but are not limited to) video files, image files, voice files, and command files including transitions and effects.

The preview module 700 allows the user to preview the contents to be edited before editing is performed, in accordance with the multimedia editing command file transmitted from the client 100. Here, the preview module 700 operates in conjunction with the video file editing module 800 and the resource database 920, and provides the video file edited through the video file editing module 800 in a streaming format when the client 100 requests the preview for the video file corresponding to the multimedia editing command file.

The video file editing module 800 edits the video file based on the resources stored in the resource database 920, in accordance with the multimedia editing command transmitted from the client 100. The resource database 920 stores the resources or resource information used in editing video files and also stores video files edited on the video file editing module 800.

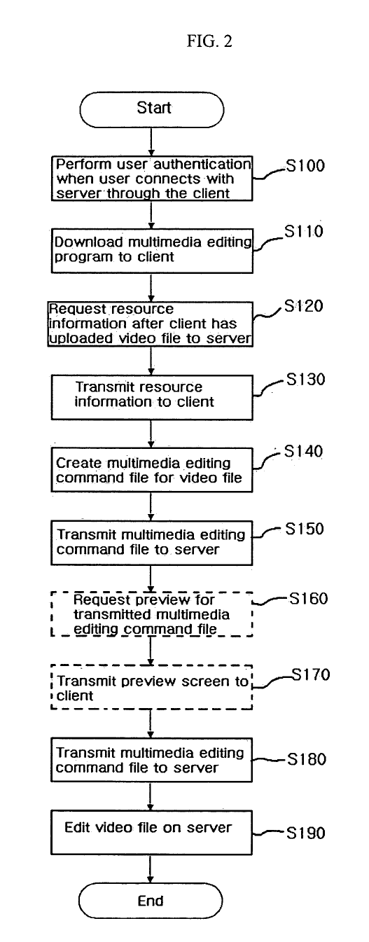

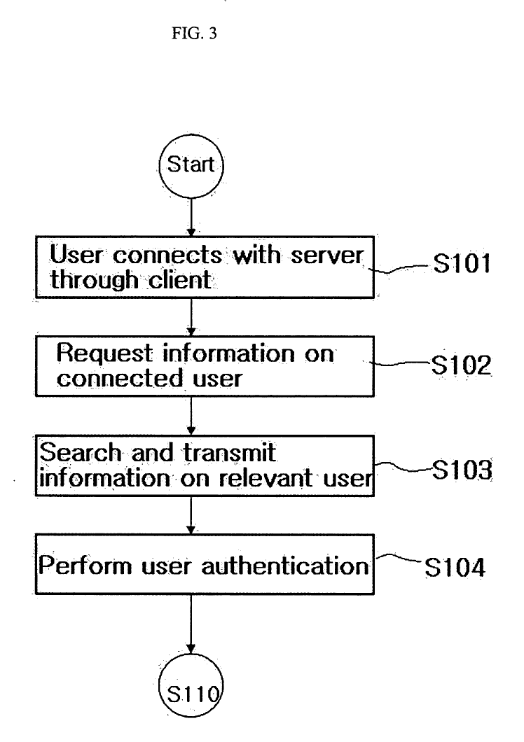

FIG. 2 is a flowchart schematically illustrating a method for editing a multimedia file using the Internet according to the present invention. FIGS. 3 to 5 are flowcharts specifically illustrating the method for editing the multimedia file using the Internet according to the present invention.

As illustrated in FIG. 2 with respect to step S101 of FIG. 1, when the user connects with the server through the client 100 (S101), the user authentication module 400 performs the authentication for the user who has connected with the server. At this time to perform the user authentication, the user authentication module 400 requests the user database 910 to send the information on the connected user (S102), and the user database 910 searches for the information on the connected user and transmits the relevant information on the connected user to the user authentication module 400 (S103). Thus, the user authentication has been finally performed (S104). When the connected user is determined to be a registered user according to the user authentication result, the connection with the server is permitted.

When the connection of the client 100 with the server is permitted, the server causes the multimedia editing program to be downloaded to the client 100 (S110). Here, it can be understood that the multimedia editing program is a web application, applet and the like.

If the multimedia editing program is downloaded to the client 100, the user uploads a video file, which has been recorded by the user, to the server. Then, the signal input/output module 300 transmits the uploaded video file to the user file upload module 500 which in turn transmits and stores the transmitted video file to and in the resource database 920. Here, the stored video file is later used in accordance with the multimedia editing commands of the client 100, when it is edited on the video file editing module 800.

Next, when the user requests the resource information so as to edit the video file on the client 100 (S120). The signal input/output module 300 receives the resource information request signal and then transmits the received signal to the resource information processing module 600.

The resource information processing module 600, which has received the resource information request signal, transmits the resource information stored in the resource database 920 to the client 100 (S130). The user can choose desired pieces of the transmitted resource information, and perform the transition by using sliding and unfolding effects, etc. to edit the recorded video according to a user preference. Further, the user can have various effects on the recorded video by using a stereoscopic effect, shape changing and the like. Moreover, a suitable title may be input into the recorded video to explain respective video pictures. Here, the user may also select the size, color, style and position of the title, but the present invention is not limited thereto.

Thereafter, when the resource information is downloaded to the client 100, the user creates the multimedia editing command file by using the multimedia editing program and the resource information (S140). Here, the creation of the multimedia editing command file on the client 100 by the user does not mean actual editing of the video file, but is only directed at creation of a command file for the editing of the video file using the resource information. That is, only the multimedia editing command file including the resource information used for editing the video file is created on the client 100, whereas the actual editing of the video file is made on the video file editing module 800, which has received the multimedia editing command file.

After the creation of the multimedia editing command file for the video file has been completed, the client 100 transmits the created multimedia editing command file to the server (S150).

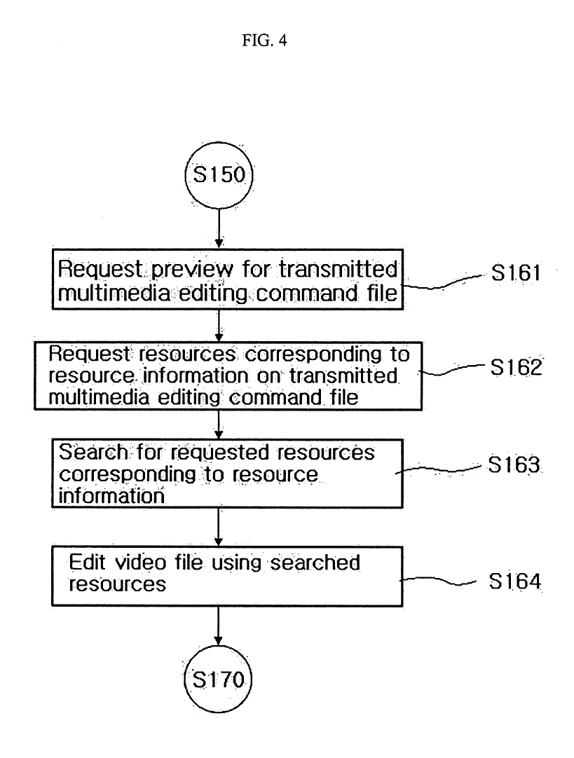

FIG. 4 illustrates additional details of step S160 (i.e., a user request for a preview for the transmitted multimedia editing command file). If necessary, the user can transfer the multimedia editing command file to the server and then request the preview of the video file corresponding to the command file (S161). The signal input/output module 300 receives the preview request signal from the user, and transmits the received preview request signal to the preview module 700. The preview module 700 requests the video file editing module 800 to edit the video file in accordance with the transmitted multimedia editing command file.

Then, the video file editing module 800 requests that the resource database 920 to transmit the resources corresponding to the resource information in the multimedia editing command file transmitted from the signal input/output module 300 (S162). Thus, the resource database 920 searches for the requested resources corresponding to the resource information and transmits the searched resources to the video file editing module 800 (S163). The video file editing module 800 edits the video file by using the transmitted resources and then transmits the edited video file to the preview module 700 (S164). The preview module 700 provides the client 100 with the edited video file in a streaming format so that the user can preview the edited video file (S170).

Next, the user checks a preview screen on which the edited video file is displayed, and executes the multimedia editing command file if there are no contents to be edited (S180). Then, the signal input/output module 300 transmits the multimedia editing command, which is received from the client 100, to the video file editing module 800. At this time, the multimedia editing command file corresponding to the multimedia editing command is also transmitted together upon transmission of the command.

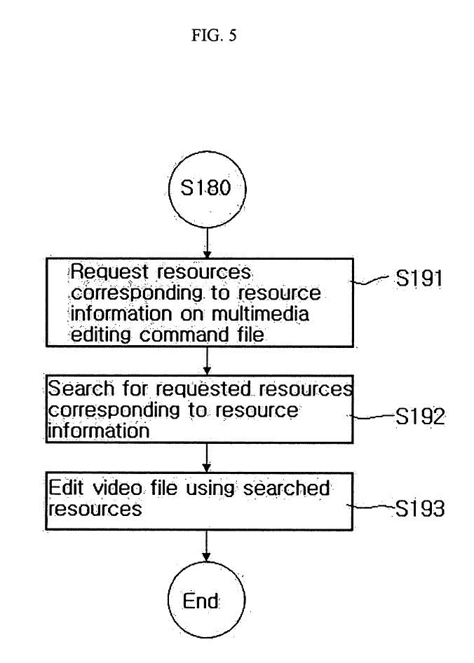

FIG. 5 illustrates the steps associated with editing the video file on the server (S190). The video file editing module 800 requests the resource database 920 to transmit the video file uploaded from the client 100 and the resources corresponding to the resource information of the transmitted multimedia editing command file (S191). Then, the resource database 920 searches for the requested resources corresponding to the resource information and transmits the searched resources to the file editing module 800 (S192). Thereafter, the file editing module 800 edits the video file by using the transmitted resources (S193).

After the editing of the video file has been completed, the edited video file is stored in the resource database 920. Here, the video file storing therein the resource database 920 may be transmitted to the client 100 at the client's request.

In the meantime, when a plurality of video file editing modules 800 are provided, a plurality of multimedia editing command files received from a plurality of clients 100 can be simultaneously processed. Alternatively, if a related art parallel processing method is employed, a single video file editing module 800 can also process the plurality of multimedia editing command files.

Furthermore, the user may retrieve the video file stored in the resource database 920 and edit the video file again. On the other hand, according to the user's preference, the user may directly execute the multimedia editing commands without checking the preview screen.

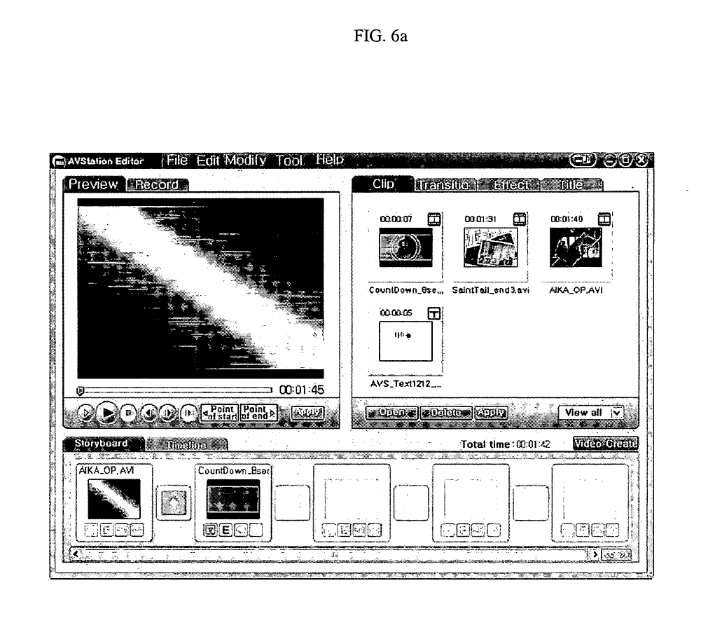

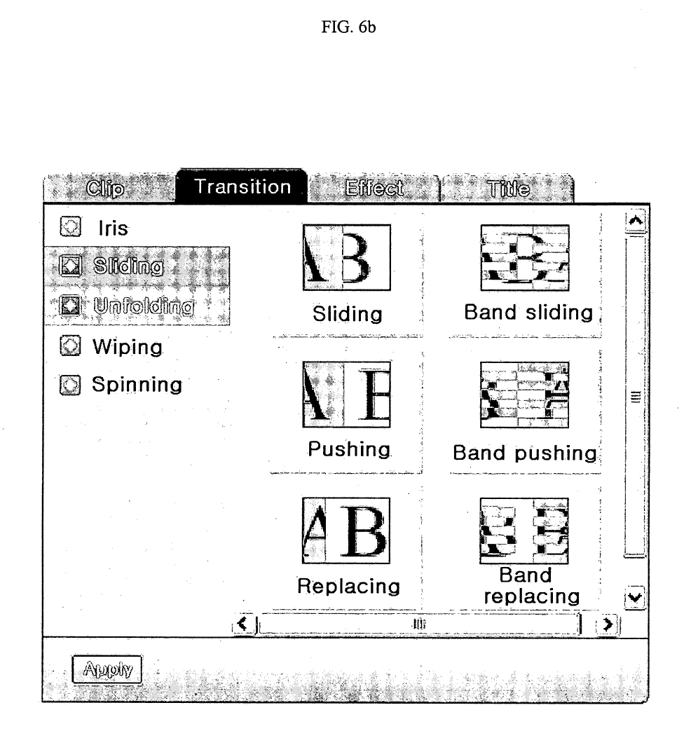

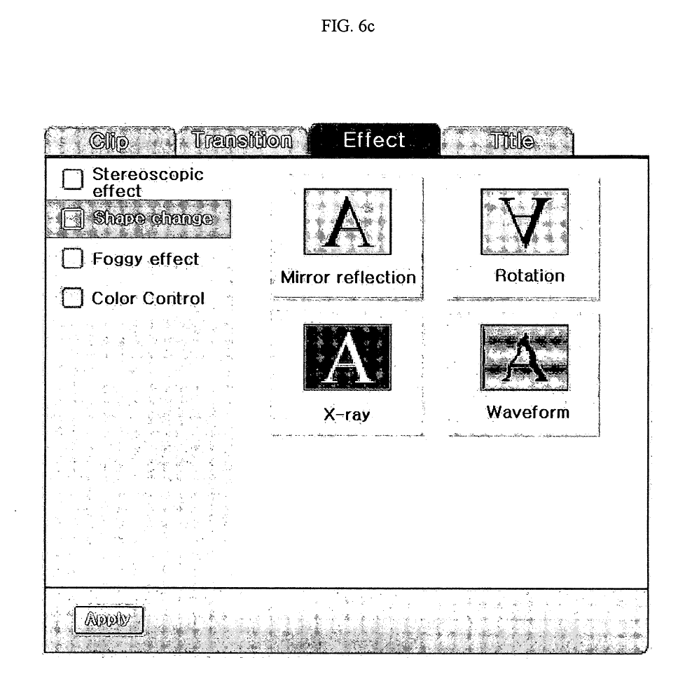

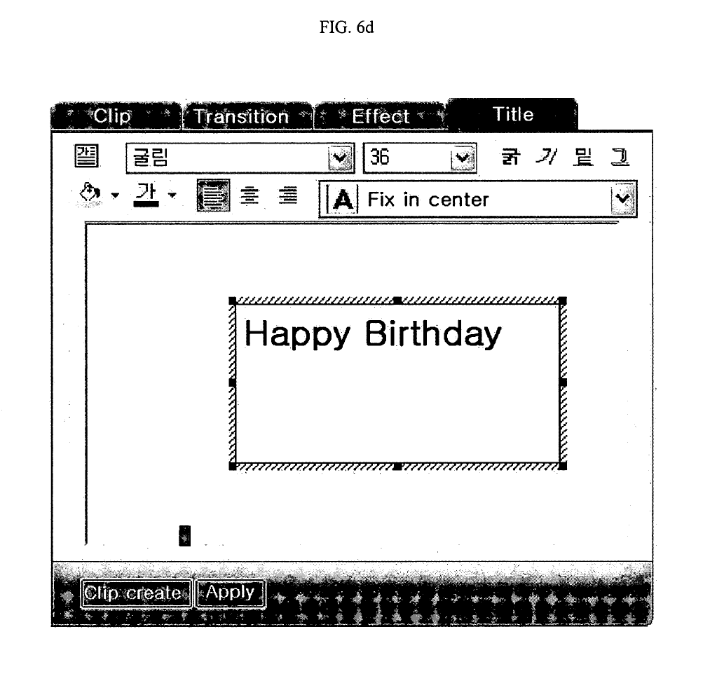

FIGS. 6a to 6d are graphics illustrating examples of editing the video using the multimedia editing program according to the present invention. FIG. 6a shows an entire screen of the multimedia editing program. In this figure, an upper left portion of the entire screen is a preview screen on which the edited contents of the video file are displayed. An upper right portion thereof is a resource view screen on which various kinds of resource information used for editing the video file are displayed, and a lower portion thereof is an editing window on which the video file is edited.

The user who intends to edit the video file through the client 100 using the multimedia editing program should first press an open button provided on the resource view screen and retrieve video files to be edited (i.e. resource information) from the server. Then, the user moves the respective retrieved video files to the editing window and selects a desired tab (transition, effect, title, etc.) from the resource view.

When the transition tab is selected from the resource view screen, the resource information on the various transitions such as iris, sliding, unfolding, wiping and spinning is displayed in the form of index menus, as shown in a left portion of FIG. 6b. When a desired piece of resource information is selected among the displayed resource information, then subordinate resource information thereof is accordingly displayed on the screen. The resource information is displayed in the form of index menus because the user can easily select the resource information.

Next, when the user selects the desired piece of a variety of transition resource information displayed on the screen and presses an apply button, the selected piece of resource information is transmitted onto the editing window.

For example, but not by way of limitation, when the user selects the sliding transition resource information, a first frame of the video is slid sideward, and the next frame thereof is displayed.

When the user selects the effect tab, the resource information on the various effects such as stereoscopic effect, shape changing, foggy effect, and color adjustment is displayed in the form of index menus, as shown in a left portion of FIG. 6c. If the user selects a desired piece of the displayed resource information, then subordinate information thereof is accordingly displayed on the screen.

For example, but not by way of limitation, when the resource information for mirror reflection is selected, the video is reversed from side to side. When the resource information for rotation is selected, the video is reversed up and down.

Next, when the title tab is selected, a text input window on which a desired title can be input is displayed as shown in FIG. 6d. When a predetermined title to be applied to the video is input to the input window and the input title is then applied to the video, the input title is displayed on the screen when the relevant video is displayed. At this time, the style, color, size, position, and the like of the title can be determined.

Furthermore, when the user requests the preview screen for the resource information, the preview screen for the relevant resource information can be provided in the streaming format since the client 100, and the preview module 700 and the resource database of the server are used in conjunction with one another.

In addition, when the user selects a timeline tab provided on the editing window, they can know an actual operating period of time of the selected resource information.

Moreover, the video editing according to the present invention can be made in the notebook computer, web pad, mobile phone as well as the computer (but is not limited thereto). Further the method of the present invention can be implemented in a computer-readable medium as instructions.

The present invention has various advantages. For example, but not by way of limitation, according to the present invention, since the multimedia editing program is downloaded to the client through the Internet, the video file can be edited without using additional program media. Thus, there is at least an advantage in that the video file can be edited at any place where the Internet is available.

Further, since only the multimedia editing program and resource information necessary for editing the multimedia file are downloaded, data transmission can be minimized. Thus, there is at least another advantage in that the load imposed on the network can be reduced.

Furthermore, the video file is not edited directly on the client, but the video file is edited in such a manner that the multimedia editing command file for the video file to be edited is created and transmitted to the server and the server edits the video file by using the resources stored therein in accordance with the transmitted multimedia editing command file. As a result, it is not necessary to edit the video file on the client and then upload the edited video file to the server. Thus, there is a further advantage in that the load imposed on the network can be substantially avoided.

Moreover, since the server edits the video file in accordance with the multimedia editing command file transmitted from the client by using the resources stored in the server, there is a still further advantage in that there is virtually no limitation on the performance of the client.

The present invention has been described in detail in connection with the preferred embodiment, but it will be apparent to those skilled in the art that various modifications or changes may be made thereto without departing from the spirit and scope of the invention as defined in the appended claims. Therefore, mere modifications to the present invention fall within the scope of the present invention.

What is claimed is:

1. A client, said client linked with a server through a network, the client operable to upload a video file to one or more network components, create a multimedia editing command file using a multimedia editing program, and request editing of the video file in accordance with the multimedia editing command file.

2. The client as claimed in claim 1, wherein the client is operable to download the multimedia editing program from the server.

3. The client as claimed in claim 1, wherein the created multimedia editing command file includes resource information downloaded by the client from the server.

4. The client as claimed in claim 3, wherein the resource information is either one of a video clip or an icon.

5. A server, said server linked to a client through a network, the server operable to receive a multimedia editing command file transmitted from the client and edit a video file stored in the server in accordance with the multimedia editing command file.

6. The server as claimed in claim 5, comprising:
a resource database that stores resource information and corresponding resources;
a user file uploading module that stores the video file and the multimedia editing command file, which is uploaded from the client to the resource database;
a resource information processing module that transmits the resource information to the client in accordance with a client request; and
a video file editing module that edits the video file by using the corresponding resources in accordance with the multimedia editing command file.

7. The server as claimed in claim 6, further comprising a preview module that allows a user to preview contents of the video file to be edited prior to editing the contents in accordance with the uploaded multimedia editing command file.

8. The server as claimed in claim 6 further comprising:
a user authentication module that performs authentication of a user connected to the server through the client; and
a user database that stores user information to be used when the user authentication is performed.

9. The server as claimed in claim 5, wherein the multimedia editing command file is created by use of a multimedia editing program downloaded by the client from the server.

10. The server as claimed in claim 6, wherein the multimedia editing command file includes the resource information, which is downloaded by the client from the server.

11. The server as claimed in claim 10, wherein the resource information is either one of a video clip or an icon.

12. A multimedia file editing system linked to a client through a network, said multimedia file editing system comprising:
a client operable to upload a video file to one or more network components, create a multimedia editing command file using a multimedia editing program, and request editing of the video file in accordance with the multimedia editing command file; and
a server operable to receive the multimedia editing command file transmitted from the client and edit the video file stored in the server in accordance with the multimedia editing command file.

13. A method for editing a multimedia file, comprising the steps of:
(1) in a client, creating a multimedia editing command file by using resource information downloaded from a server;
(2) transmitting the created multimedia editing command file to the server; and
(3) in the server, editing a video file by using resources stored in the server that correspond to the resource information used to create the transmitted multimedia editing command file.

14. The method as claimed in claim 13, wherein the step (3) comprises the steps of:
downloading a multimedia editing program by the client from the server;
uploading the video file to the server;
downloading the resource information by the client from the server; and
displaying the downloaded resource information through the multimedia editing program.

15. The method as claimed in claim 13, wherein the step (3) comprises the steps of:
searching for the resources corresponding to the resource information used to create the transmitted multimedia editing command file from a resource database; and
editing the video file by using the searched resources.

16. The method as claimed in claim 15, further comprising the step of providing the edited video file in the form of a preview screen.

17. The method of claim 16, further comprising:
requesting a preview for said transmitted multimedia editing command file;
requesting the resources corresponding to the resource information used to create the transmitted multimedia editing command file;
searching for said requested resources by the server; and
editing the video file using said requested resources.

18. The method of claim 13, wherein the resource information is either one of a video clip or an icon.

19. A method of editing a multimedia file, comprising the steps of:
(1) receiving a multimedia editing command file created by a client using resource information and transmitted by the client; and
(2) editing, on the server's side, a video file in accordance with the multimedia editing command file.

20. The method as claimed in claim 19, wherein the step (2) comprises the steps of:
searching for resources corresponding to the resource information in the transmitted multimedia editing command file from a resource database; and
editing the video file by using the searched resources.

21. The method as claimed in claim 20, further comprising the step of providing the edited video file in the form of a preview screen.

22. The method as claimed in claim 20, further comprising:
requesting a preview for said transmitted multimedia editing command file;
searching for the resource information on the transmitted multimedia editing command file;
editing a video file using said requested resources; and
providing the edited video file in the form of a preview screen.

23. The method of claim 19, wherein the resource information is either one of a video clip or an icon.

24. A computer readable medium containing a set of instructions for editing a multimedia file, said instructions comprising the steps of:
receiving a multimedia editing command file created by a client using resource information and transmitted by the client; and
(2) editing a video file in accordance with the received multimedia editing command file.

25. The computer readable medium as claimed in claim 24, wherein the step (2) comprises the steps of:
searching for resources corresponding to resource information in the transmitted multimedia editing command file from a resource database; and
editing the video file by using the searched resources.

26. The computer readable medium as claimed in claim 25, said instructions further comprising the step of providing the edited video file in the form of a preview screen.

27. The computer readable medium as claimed in claim 25, said instructions further comprising:
requesting a preview for said transmitted multimedia editing command file;
searching for the resource information on the transmitted multimedia editing command file;
editing a video file using said requested resources; and
providing the edited video file in the form of a preview screen.
